(19) United States
(12) Patent Application Publication
(10) Pub. No.: US 2014/0193229 A1
(43) Pub. Date: Jul. 10, 2014

(54) WASTE-MATERIAL BUCKET

(71) Applicant: SHENZHEN CHINA STAR OPTOELECTRONICS TECHNOLOGY CO., LTD., Shenzhen, Guangdong (CN)

(72) Inventors: Yuewei Xu, Shenzhen (CN); Hongtao Deng, Shenzhen (CN)

(21) Appl. No.: 13/813,428

(22) PCT Filed: Jan. 8, 2013
(86) PCT No.: PCT/CN2013/070182

§ 371 Date: Jan. 31, 2013

(30) Foreign Application Priority Data
Jan. 4, 2013 (CN) 201320002585.1

(51) Int. Cl. B65D 88/56; B65F 1/12

(52) U.S. Cl. CPC B65D 88/56; B65F 1/12
USPC 414/332

(57) ABSTRACT

The present disclosure provides a waste-material bucket, including a bucket body, a base, and a locker. The bucket body includes a supporting portion respectively having an arch-shaped surface located at a front side of the bucket body, and a gravity of the bucket body is deviated to the front side of the bucket body. The base forms a guiding track for supporting the supporting portion. The locker is located at a rear side of the bucket body for locking the bucket body. The locker is unlocked to incline the bucket body forward along the at least one guiding track due to the own gravity of the bucket, which dumps the waste material conveniently in the bucket body without using the forklift. Additionally, damage of the waste-material bucket and safety threaten to the operator can be avoided since the waste-material bucket is not turned over by the forklift.

### BACKGROUND

1. Technical Field

The present disclosure relates to manufacturing technologies of liquid crystal panels, and particularly, to a waste-material bucket for holding waste material produced in manufacturing process.

2. Description of Related Art

Much glass waste material is produced in the manufacturing process of a liquid crystal panel. The waste material is held in a waste-material bucket at first, and then the waste-material bucket is transferred to a predetermined position by a forklift. In order to meet the requirements about volume, the size of the waste-material bucket is relatively large. However, the present waste-material bucket generally includes a square-shaped bucket body with a number of supporting legs arranged on a bottom portion of the square-shaped bucket. The waste-material bucket is placed on the ground and is so heavy that the waste material in the bucket cannot be dumped manually. The forklift is used for dumping the waste material in the bucket by arousing one end of the waste-material bucket and turning the waste-material bucket upside down. On one hand, dumping the waste material in the waste-material bucket in this way needs the forklift, which is inconvenient; on the other hand, since the full waste-material bucket is so heavy that the waste-material bucket may be damaged during the process of being turned upside down, which is also dangerous to the operator.

### SUMMARY

Main purpose of the present disclosure is to provide a waste-material bucket which can dump the waste-material therein safely, conveniently, and quickly.

In order achieve the above purpose, the present disclosure provides a waste-material bucket with the gravity thereof being deviated forward and being locked at a rear side thereof. The waste-material bucket is inclined forward when being unlocked to dump the waste material in the waste-material bucket.

The waste-material bucket provides in the present disclosure includes:

a bucket body comprising at least one supporting portion respectively having an arch-shaped surface located at a front side of the bucket body, and a gravity of the bucket body being deviated to the front side of the bucket body;

a base forming at least one guiding track for supporting the at least one supporting portion; and

a locker located at a rear side of the bucket body for locking the bucket body, and the locker being unlocked to allow the bucket body to be inclined forward along the at least one guiding track due to the own gravity of the bucket.

Preferably, the waste-material bucket further includes at least one restricting device for restricting the bucket body from separating from the base.

Preferably, each restricting device is a restricting chain with two ends thereof respectively connected to the bucket body and the base, the restricting chain restricts the bucket body from being inclined continuously when an inclination degree of the bucket body reaches a predetermined point.

Preferably, each restricting device is a restricting block vertically or laterally protruding from two sides of the base, and the restricting block restricts the bucket body from being continuously inclined when an inclination degree of the bucket body reaches a predetermined point.

Preferably, each guiding track forms at least one positioning slot, and each supporting portion forms at least one positioning slot engageable with the positioning slot.

Preferably, the at least one positioning slot is a number of positioning holes vertically arranged along the corresponding guiding track, and the at least one positioning block is a number of positioning posts protruding from the corresponding supporting portion and being respectively engageable with the positioning holes.

Preferably, the bucket body includes a chamber for holding waste material, and the chamber includes at least one inclined surface for generating a force along the gravitational direction.

Preferably, the base further forms an inserting slot in which a forklift is inserted.

Preferably, the locker is connected to the base or is integrally formed with the base, the locker includes a locking member with an opening and a clamping member capable of being opened and closed, and one protrusion extends from the bucket body into the opening.

The present disclosure further provides another waste-material bucket, including:

a bucket body including at least one supporting portion respectively having an inclined surface located at a front side of the bucket body, and the gravity of the bucket body being deviated to the front side of the bucket body;

a base forming at least one track for supporting the at least one supporting portion; and

a locker located at a rear side of the bucket body for locking the bucket body, the locker being unlocked to allow the bucket body to be inclined forward along the at least one guiding track due to the own gravity of the bucket.

The gravity of the bucket body of the waste-material of the present disclosure is deviated forward, the bucket body is locked to the base at the rear side thereof, the supporting portions for supporting the bucket body respectively includes the arch-shapes surface of inclined surface which is located at the front side of the bucket body, therefore, the bucket body is automatically inclined forward after being unlocked along the arch-shaped surface or the inclined surface due to the gravity of thereof to dump the waste material in the bucket body, which allows for the safe, quick, and convenient dumping of the waste material.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a rear view of a waste-material bucket in accordance with a first embodiment of the present disclosure;

FIG. 2 is a side view of the waste-material bucket of FIG. 1;

FIG. 3 is a front view of the waste-material bucket of FIG. 1; and

FIG. 4 is a schematic view showing that the waste-material bucket of FIG. 1 dumps the waste material.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

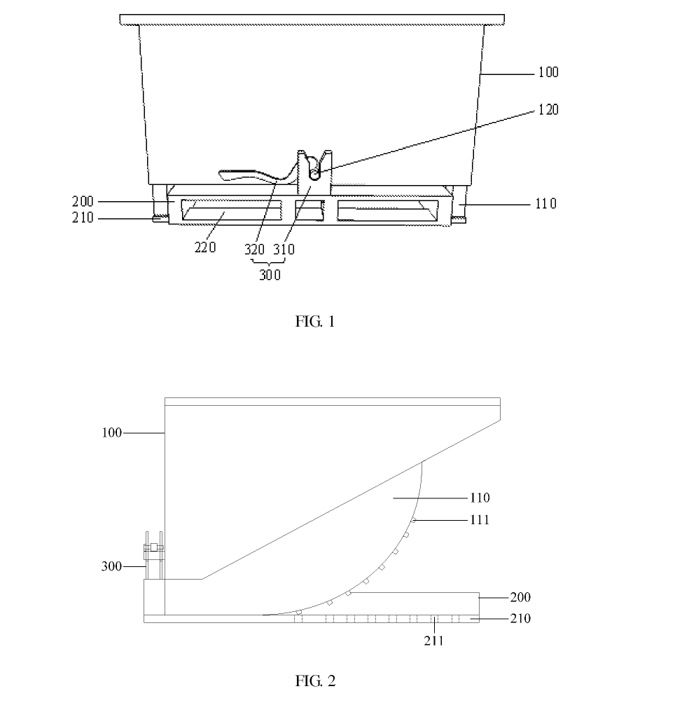

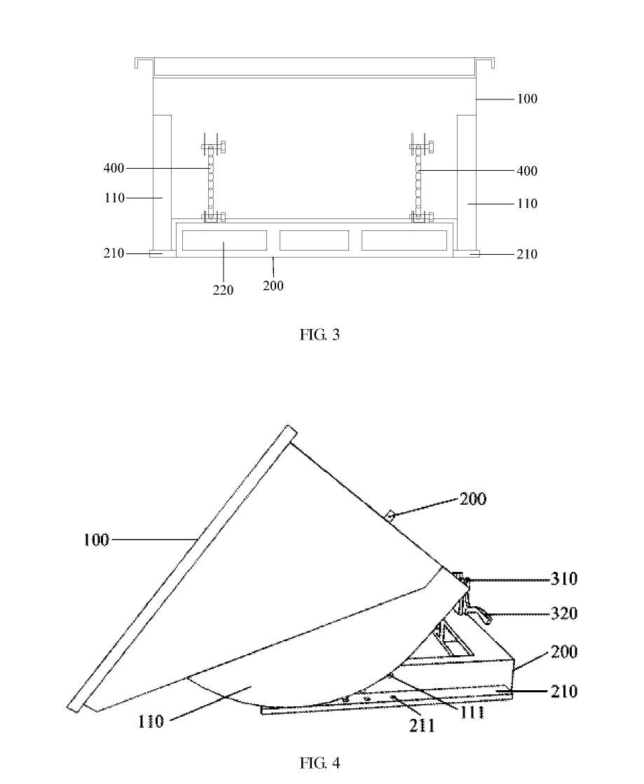

Referring to FIGS. 1 to 4, the present disclosure provides a waste-material bucket in accordance with a first embodiment. The waste-material bucket includes a bucket body 100, a base 200, and a locker 300. The bucket body 100 defines a chamber for holding waste material. The chamber includes an inclined surface for generating a force along the gravitational direction. For example, the chamber can be triangular shaped, trapezoid shaped, or suitably shaped, and the inclined surface is located at a front side of the bucket body 100, which allows the gravity of the bucket body 100 to generate a forward force and thus deviates the gravity of the bucket body 100 forward. Two supporting portions 110 are respectively located at two sides of the bucket body 100 each which includes an arch-shaped surface located at the front side of the bucket body 100. Two guiding tracks 210 are respectively arranged on the base 200 for respectively supporting the supporting portions 110. The arch-shaped surface of each supporting portion 110 can slide along the corresponding guiding track 210, thereby inclining the bucket body 100 on the base 200 along the guiding track 210. The locker 300 is arranged at a rear side of the bucket body 100 for overcoming the gravity of the bucket body 100 and locking the bucket body 100 to the base 200. When the locker 300 is unlocked, the bucket body 100 is inclined forward to dump the waste material in the bucket body 100. The locker 300 includes a locking member 310 and a clamping member 320 which are arranged on the base 200 or connected to the base 200. An opening is defined in the locking member 310 and a protrusion 120 extends from the bucket body 100 into the opening. The clamping member 320 is flexibly connected to the locking member 310 to close and open the opening. Alternatively, the locker 300 may be arranged in the bucket body 100 and the protrusion 120 may extend from the base 200 into the locking member 310. The base 200 further forms an inserting slot 220 in which a fork of a forklift is inserted to lift the whole waste-material bucket and transfer it to a predetermined location.

After the protrusion 120 of the bucket body 100 is inserted into the opening of the locking member 310, the clamping member 320 is moved to close the opening to lock the bucket body 100 to the base 200, which keeps the bucket body 100 standing upright. In this way, waste material can be held in the bucket body 100. After the bucket body 100 is full with waste material, the fork of the forklift is inserted into the inserting slot 220 to transfer the waste-material bucket to the predetermined location. After the bucket body 100 is at the predetermined location, the clamping member 320 is moved to open the opening allow and the protrusion 120 to run out of the opening due to its own gravity. The supporting portions 110 is slidable along the guiding track 210 to incline the bucket body 100 forward to dump the waste material in the bucket body 100. After the dumping of the waste material is finished, the bucket body 100 is pushed to roll towards the locker 300 until the protrusion 120 of the bucket body 100 is inserted into the opening of the locking member 310. Then the clamping member 320 is moved to close the opening to lock the bucket body 100 to the base 200 again.

In the embodiment, each supporting portion 110 includes the arch-shaped surface located at the front side of the bucket body 100 and the gravity of the bucket body 100 is deviated forward, thus, the bucket body 100 can be inclined forward along the arch-shaped surface due to its own gravity to dump the waste material in the bucket body 100, which allows the dumping of the waste material to be convenient.

Furthermore, two restricting devices 400 are provided to restrict the bucket body 100 from separating from the base 200 when being inclined forward. The restricting devices 400 are used for restricting the inclination degree of the bucket body 100 to prevent each supporting portion 110 from separating from the corresponding guiding track 210 when sliding along the guiding track 210, to prevent the bucket body 100 from separating from the base 200, and further to avoid the inconvenience caused when the locker 300 locks the bucket body 100 again. Each restricting device 400 in the embodiment is preferably a restricting chain with two ends thereof respectively being in screw connection or welding connection with the bucket body 100 and the base 200. The length of the restricting chain is set according to requirements, therefore, when the inclination degree of the bucket body 100 reaches a point, the restricting chain pulls the bucket body 100 tightly to prevent the bucket body 100 from being continuously inclined.

In other embodiments, each restricting device 400 can be a restricting block. The restricting block can be integrally formed with the base 200 or be fixed to the base 200. The restricting block laterally protrudes from two sides of a distal end of the base 200. When the inclination degree of the bucket body 100 is greatest, the restricting block blocks the supporting portions 110 of the bucket body 100 to prevent the bucket body 100 from being inclined continuously. It is noted that the restricting blocks may vertically protrude from the middle portion of the base 200 to abut the bucket body 100 when the inclination degree of the bucket body 100 reaches a point and further to prevent the bucket 100 from being continuously inclined.

Furthermore, each guiding track 210 of the base 200 forms at least one positioning slot 211, and each supporting portion 110 of the bucket body 100 forms at least one positioning block 111 engageable with the positioning slot 211. The least one positioning slot 211 can be a long and narrow slot extending along the corresponding guiding track 210, correspondingly, the at least one positioning block 111 is a long and narrow block protruding from the bottom surface of the corresponding supporting portion 110, which restricts the position of the bucket body 100 and avoids the movement of the bucket body 100. In the embodiment, the at least one positioning slot 211 is preferably a number of positioning holes vertically arranged along the corresponding guiding track 210, and the at least one positioning block is a number of positioning posts protruding from the corresponding supporting portion 110 and being engageable with the positioning holes. When the bucket body 100 rolls along the guiding track 210, the positioning posts respectively mesh with the positioning holes to restrict the position of the bucket body 100 when the bucket body 100 rolls along the guiding track 210, which stabilizes and secures the rolling of the bucket body 100.

In the embodiment, each supporting portion 110 of the bucket body 100 includes the arch-shaped surface. In other embodiments, the bucket body 100 can be automatically inclined by replacing the arch-shaped surface with inclined surface. That is, the arch-shaped surface can be replaced by a large inclined surface or a number of successive small inclined surfaces without changing other components mentioned above. In this way, the gravity of the bucket 100 can still be deviate forward. After the locker 300 located at the rear side of the bucket body 100 is unlocked, the bucket body 100 is inclined forward due to its own gravity along the guiding tracks 210. It is noted that with the arch-shaped surface, the bucket body 100 can be inclined stably and safely, thus, the arch-shaped surface is preferred.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A waste-material bucket, comprising:
a bucket body comprising at least one supporting portion respectively having an arch-shaped surface located at a front side of the bucket body, and a gravity of the bucket body being deviated to the front side of the bucket body;
a base forming at least one guiding track for supporting the at least one supporting portion; and
a locker located at a rear side of the bucket body for locking the bucket body, the locker being unlocked to allow the bucket body to be inclined forward along the at least one guiding track due to the own gravity of the bucket.

2. The waste-material bucket of claim 1 further comprising at least one restricting device for restricting the bucket body from separating from the base.

3. The waste-material bucket of claim 2, wherein each restricting device is a restricting chain with two ends thereof respectively connected to the bucket body and the base, and the restricting chain restricts the bucket body from being inclined continuously when an inclination degree of the bucket body reaches a predetermined point.

4. The waste-material bucket of claim 2, wherein each restricting device is a restricting block vertically or laterally protruding from two sides of the base, and the restricting block restricts the bucket body from being continuously inclined when an inclination degree of the bucket body reaches a predetermined point.

5. The waste-material bucket of claim 1, wherein each guiding track forms at least one positioning slot, and each supporting portion forms at least one positioning slot engageable with the positioning slot.

6. The waste-material bucket of claim 5, wherein the at least one positioning slot is a number of positioning holes vertically arranged along the corresponding guiding track, and the at least one positioning block is a number of positioning posts protruding from the corresponding supporting portion and being respectively engageable with the positioning holes.

7. The waste-material bucket of claim 1, wherein the bucket body comprises a chamber for holding waste material, the chamber comprises at least one inclined surface for generating a force along the gravitational direction.

8. The waste-material bucket of claim 1, wherein the base further forms an inserting slot in which a forklift is inserted.

9. The waste-material bucket of claim 1, wherein the locker is connected to the base or is integrally formed with the base, the locker comprises a locking member with an opening and a clamping member capable of being opened and closed, and one protrusion extends from the bucket body into the opening.

10. A waste-material bucket, comprising:
a bucket body comprising at least one supporting portion respectively having an inclined surface located at a front side of the bucket body, and the gravity of the bucket body being deviated towards the front side of the bucket body;
a base forming at least one track for supporting the at least one supporting portion; and
a locker located at a rear side of the bucket body for locking the bucket body, the locker being unlocked to allow the bucket body to be inclined forward along the at least one guiding track due to the own gravity of the bucket.

11. The waste-material bucket of claim 10 further comprising at least one restricting device for restricting the bucket body from separating from the base.

12. The waste-material bucket of claim 11, wherein each restricting device is a restricting chain with two ends thereof respectively connected to the bucket body and the base, and the restricting chain restricts the bucket body from being inclined continuously when an inclination degree of the bucket body reaches a predetermined point.

13. The waste-material bucket of claim 11, wherein each restricting device is a restricting block vertically or laterally protruding from two sides of the base, and the restricting block restricts the bucket body from being continuously inclined when an inclination degree of the bucket body reaches a predetermined point.

14. The waste-material bucket of claim 10, wherein each guiding track forms at least one positioning slot, and each supporting portions forms at least one positioning slot engageable with the positioning slot.

15. The waste-material bucket of claim 10, wherein the bucket body comprises a chamber for holding waste material, and the chamber comprises at least one inclined surface for generating a force along the gravitational direction.

16. The waste-material bucket of claim 10, wherein the base further forms an inserting slot in which a forklift is inserted.
